(19) United States
(12) Patent Application Publication
(10) Pub. No.: US 2024/0153494 A1
(43) Pub. Date: May 9, 2024

(54) TECHNIQUES FOR GENERATING TRAINING DATA FOR ACOUSTIC MODELS USING DOMAIN ADAPTATION

(71) Applicant: GONG.io Ltd., Ramat Gan (IL)

(72) Inventors: Eyal COHEN, Tel Aviv (IL); Eduard GOLSTEIN, Petah Tiqwa (IL)

(73) Assignee: GONG.io Ltd., Ramat Gan (IL)

(21) Appl. No.: 18/053,233

(22) Filed: Nov. 7, 2022

(51) Int. Cl. G10L 15/06; G10L 13/047; G10L 15/16; G10L 15/187; G10L 25/18

(52) U.S. Cl. CPC G10L 15/063; G10L 13/047; G10L 15/16; G10L 15/187; G10L 25/18

(57) ABSTRACT

A system and method for audio processing. A method includes synthesizing an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and training an acoustic model using the synthesized audio data set.

### TECHNICAL FIELD

The present disclosure relates generally to audio processing, and more particularly to preparing training data to be used for training acoustic models via machine learning.

### BACKGROUND

Audio processing, and particularly the processing of audio content including speech, is a critical component of any computer-implemented speech recognition program used for understanding and acting upon words said during conversations. Various solutions for processing speech content exist. In particular, several solutions utilize one or more models for purposes such as recognizing the language being spoken during a conversation, the sounds being made, and more. To this end, automated speech recognition systems often include components such as an acoustic model and a language model (e.g., a language identification model).

An acoustic model typically handles the analysis of raw audio waveforms of human speech by generating predictions for the phoneme (unit of sounds) or letter each waveform corresponds to. The waveforms analyzed by the acoustic model are extremely nuanced. Not only can they be based on actual sounds produced by a given speaker, but they can also be influenced by background noise from the environment in which the sounds are captured.

Acoustic models may be trained to make predictions of acoustics using machine learning techniques. Although using machine learning to create acoustic models provide promising new ways to produce accurate acoustic predictions, training a machine learning model to make accurate predictions typically requires a large amount of training data. When attempting to tailor an acoustic model for a specific purpose (e.g., based on speech audio from a particular organization), a suitable amount of audio data related to that purpose may not be readily available. In such a case, a person seeking to train an acoustic model may seek out publicly available data (e.g., data available via the Internet). However, such publicly available data may be unsuitable quality. In such cases, poor-quality data cannot be used to train the acoustic model or else the acoustic model's predictions will be very inaccurate.

Solutions which allow for effectively leveraging large amounts of unknown quality data to train acoustic models are therefore highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for audio processing. The method comprises: synthesizing an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and training an acoustic model using the synthesized audio data set.

Certain embodiments disclosed herein also include a non-transitory computer readable medium having stored thereon causing a processing circuitry to execute a process, the process comprising: synthesizing an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and training an acoustic model using the synthesized audio data set.

Certain embodiments disclosed herein also include a system for audio processing. The system comprises: a processing circuitry; and a memory, the memory containing instructions that, when executed by the processing circuitry, configure the system to: synthesize an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and train an acoustic model using the synthesized audio data set.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for training an acoustic model using synthetic training data according to an embodiment.

FIG. 3 is a flowchart illustrating a method for training models of a generative adversarial network in coordination with a decoder according to an embodiment.

FIG. 4 is a flowchart illustrating a method for creating synthetic audio data according to an embodiment.

FIGS. 5A-C are flow diagrams utilized to illustrate various disclosed embodiments.

FIG. 6 is a schematic diagram of a synthetic audio composer according to an embodiment.

### DETAILED DESCRIPTION

The various disclosed embodiments provide improved techniques for processing audio content and, in particular, audio content containing speech. More particularly, the disclosed embodiments provide techniques for creating training data sets to be used for training acoustic models which allow for leveraging high volumes of data having unknown quality while mitigating any negative effects on the accuracy of the resulting acoustic models. The disclosed embodiments utilize a decoder in coordination with a generative adversarial network in order to adapt a generator model to generate synthetic data in a particular domain.

In an embodiment, a generative adversarial network (GAN) including a generator and a discriminator is trained in coordination with a decoder during a series of training iterations. Each of the generator and the discriminator is a machine learning model which may initially have randomly set weights and are trained, during the iterations, to learn how to generate authentic-seeming synthetic data and to discriminate between authentic and inauthentic data, respectively. Each of the generator and the discriminator further has a loss function used by the respective model to determine a loss in its respective process at each iteration.

The generator is configured to generate synthetic training data in a second domain using original training data in a first domain. To this end, original training data in a form such as a spectrogram in a first domain is input to the generator, which proceeds to generate synthetic training data in a form such as a spectrogram in a second domain.

Both the original training data and the synthetic training data are input to the discriminator. The discriminator is trained to output a decision on whether the synthetic training data is real (authentic) or fake (inauthentic). Synthetic training data which is determined to be fake by the discriminator may be discarded and not used for subsequent training iterations. Over the series of iterations, the generator is improved in order to output synthetic spectrogram data which appears more authentic, and the discriminator becomes trained to better determine whether data is authentic, which in turn allows for further refining the generator.

The decoder is configured to decode the synthetic data in the second domain produced by the generator in order to create synthetic data in the first domain. The synthetic data in the first domain produced by the decoder may be compared to the original training data in the first domain in order to determine a loss of the decoder, referred to as the decoder loss.

The errors by the generator and the discriminator of the GAN as determined using their respective loss functions result in some loss across the GAN, referred to as GAN loss. The GAN loss and the decoder loss may be summed in order to determine a total loss for the system, which is input to the generator as feedback in order to further improve the generator.

Once the generator has been trained over iterations using the feedback related to losses by the discriminator and the decoder, the generator may be applied to new input data in one domain in order to create synthetic application data in another domain. The synthetic application data may be input to a vocoder in order to produce synthetic audio content which may be utilized to train an acoustic model, for example by extracting features from that synthetic audio content and training the acoustic model using those extracted features.

In light of the challenges noted above, it has been identified that ample data is publicly available, for example via the Internet, for training acoustic models, but that much of the publicly available data is poor quality or otherwise unsuitable for use. Moreover, even when such publicly available data is of suitable quality, the data may not be in the domain utilized by the acoustic model, i.e., the values included among that data may not belong to the potential values utilized by the acoustic model. The disclosed embodiments provide techniques that allow for leveraging the vast amount of data publicly accessible via sources like the Internet while maintaining the accuracy of any models (such as acoustic models) trained using such data. More specifically, the synthetic audio content produced using the GAN trained as discussed above can be utilized to obtain training features for use in training the acoustic model. Moreover, because the generator of the GAN is trained to generate synthetic domain in a different domain, the generator may be further configured to produce synthetic data in an appropriate domain used by the acoustic model such that, through training, the generator is trained to produce authentic-seeming synthetic data in the second domain.

It is also noted that GANs are used in some existing solutions for processing images (for example, by using such GANs to create synthetic images or modify existing images), but that GANs face unique challenges when used for other purposes. In particular, training a GAN to produce authentic-seeming synthetic audio content often requires a large amount of sample data, but that a sufficient amount of data may not be readily available. This is particularly problematic when training an acoustic model for a specific purpose (e.g., when the acoustic model is to be applied to audio content containing multiple languages or audio content containing subject-specific key terms), which may require more data in order to fully learn the unique characteristics of the data relevant to its intended purpose.

It is further noted that a major challenge when using GANs is that a GAN may map every input to respective outputs, even when such mapping would require mapping some inputs to outputs which do not actually correspond to the initial inputs. Using decoder loss as additional feedback on top of the GAN losses as described herein provides additional contextual data that further improves the accuracy of the resulting synthetic data. Thus, the disclosed embodiments allow for leveraging the large volume of publicly available data while using feedback including decoder loss to mitigate any over mapping issues which would result in less authentic synthetic data.

Additionally, the discriminator, as noted above, is trained to determine whether synthetic data output by the generator is likely to be real or fake. Any synthetic data which is real may be utilized during subsequent iterations to further train the GAN, while synthetic data which is fake may be discarded and ignored during subsequent processing. Thus, the discriminator may be used both to improve the training of the generator to generate more accurate synthetic data as well as to filter out fake data, thereby reducing the amount of data to be processed during subsequent iterations as compared to solutions which do not filter out such fake data.

The disclosed embodiments therefore provide new ways of obtaining training data suitable for use in training models which utilize features extracted from audio content and, in particular, acoustic models. The synthetic training data created for use in training the acoustic model as described herein retains the relevant acoustical properties of data in the original domain which are relevant to the new domain, thereby allowing for effectively leveraging data of unknown domain and quality in order to train an acoustic model to make accurate predictions.

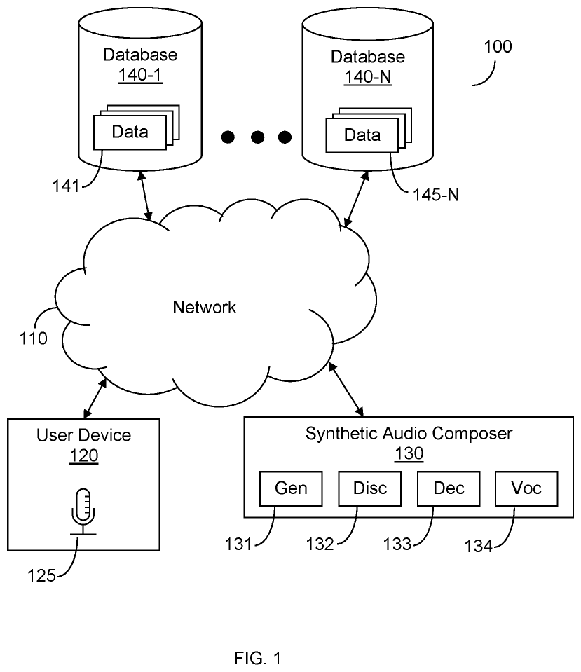

FIG. 1 shows an example network diagram 100 utilized to describe the various disclosed embodiments. In the example network diagram 100, a user device 120, a synthetic audio composer 130, and a plurality of databases 140-1 through 140-N (hereinafter referred to individually as a database 140 and collectively as databases 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWWV), similar networks, and any combination thereof.

The user device (UD) 120 may be, but is not limited to, a personal computer, a laptop, a tablet computer, a smartphone, a wearable computing device, or any other device capable of receiving speech recognition outputs and utilizing those outputs for one or more user-facing functions. As non-limiting examples, the user device 120 may be configured to use speech recognition outputs for speech-to-text functions (e.g., for closed captioning or speech-to-text logging), for voice-activated commands (e.g., commands to a virtual agent or a self-driving vehicle), for voice-based authentication, combinations thereof, and the like.

The user device 120 may be further equipped with one or more input/output (I/O) devices and, in particular, audio-based I/O devices such as one or more microphones 125. The microphones 125 may be used to capture audio content containing speech (i.e., speech spoken by a user of the user device 120 or by others within capturing range of the microphones) in order to provide the synthetic audio composer 130 with audio content to be processed by an acoustic model trained in accordance with various disclosed embodiments.

In an embodiment, the synthetic audio composer 130 is configured to produce synthetic audio using a network of machine learning models trained as described herein. To this end, in accordance with various disclosed embodiments, the synthetic audio composer 130 includes a generator (Gen) 131, a discriminator (Disc) 132, a decoder (Dec) 133, and a voice encoder (Voc) 134. Each of the generator 131, the discriminator 132, a decoder 133, and a voice encoder 134 may be, but is not limited to, a discrete logical or hardware component of the synthetic audio composer 130. In particular, each of the components 131 through 134 is or includes a model configured for a particular function. At least some of these models are machine learning models and, in particular, machine learning models trained as discussed herein.

The generator 131 is configured to generate synthetic audio-related data in the form of, for example, a spectrogram in a domain of an acoustic model (not shown). The discriminator 132 is configured to categorize the synthetic data generated by the generator 131 as either real (authentic) or fake (inauthentic). In accordance with various disclosed embodiments, each of the generator 131 and the discriminator 132 has a respective loss function (not depicted). The generator 131 is input original audio-related data (e.g., original spectrograms) from one or more data sources such as the data 145 stored in the databases 140. As noted above, the databases 140 may be publicly available databases, and the data 145 may be data of unknown quality and for which the domain of the data 145 is unknown.

The decoder 132 is configured to decode data the synthetic data in a second domain generated by the generator 131 into synthetic data in a first domain (e.g., a domain of the original data). This synthetic data in the first domain may be compared to the original data in order to determine a loss related to the decoder which is utilized to create feedback for the generator 131 during training.

The voice encoder, or vocoder, 134 is configured to generate audio content using audio-related data such as spectrograms. When applied to the synthetic data generated by the generator 131, the voice encoder 134 produces synthetic audio data which can be utilized for training an acoustic model (not shown).

In various embodiments (not specifically depicted in FIG. 1), the synthetic audio composer 130 has stored thereon an acoustic model, a speech recognition model, other models used for speech recognition, and the like. The acoustic model is trained using features from the synthetic audio data produced by the vocoder 134. The acoustic model may then be applied to audio data, for example audio data captured by the microphone 125 of the user device 120, in order to make predictions of acoustics in the audio data. Such predictions may be utilized to perform various speech recognition processes as would be understood to persons having ordinary skill in the art.

It should be noted that the components 131 through 134 as well as the speech recognition-related models are described as being part of a single synthetic audio composer 130 with respect to FIG. 1 for simplicity purposes, but that any or all of these components and models may be implemented as or in separate systems without departing from the scope of the disclosure.

It should also be noted that the user device 120 and the synthetic audio composer 130 are depicted as separate entities for the sake of discussion, but that at least a portion of the functions performed by the synthetic audio composer 130 may be performed by the user device 120 and vice versa without departing from the scope of the disclosure.

For example, the user device 130 may have stored thereon the acoustic model and may be configured to utilize any or all of the components 131 through 134 in order to generate synthetic audio data to be utilized for training the acoustic model. The user device 120 may be further configured to train and apply the acoustic model on, for example, features of the audio data captured via the microphone 125.

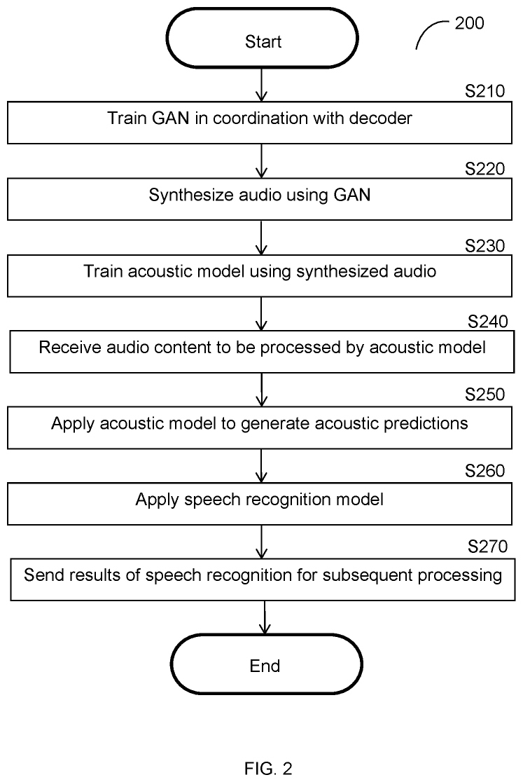

FIG. 2 is a flowchart illustrating a method for training an acoustic model using synthetic training data according to an embodiment.

FIG. 2 is a flowchart 200 illustrating a method for training an acoustic model using synthetic training data according to an embodiment. In an embodiment, the method is performed by the synthetic audio composer 130, FIG. 1.

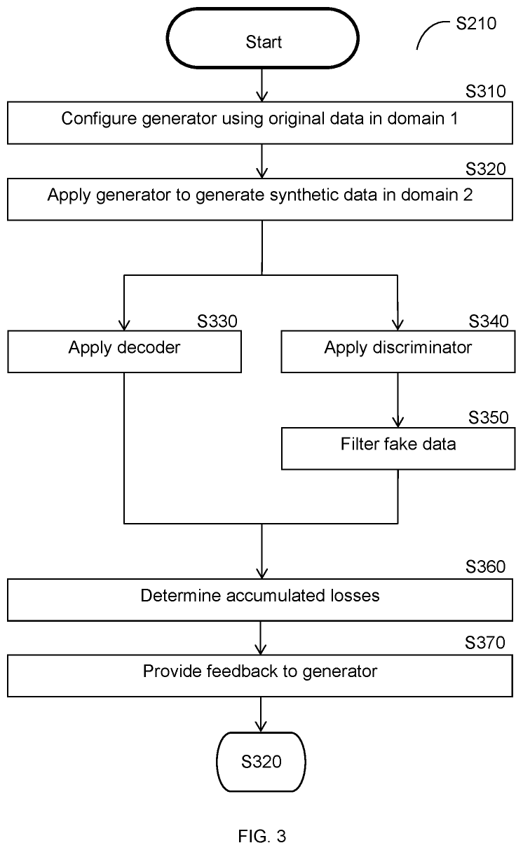

At S210, a generative adversarial network (GAN) is trained in coordination with a decoder. More specifically, data related to losses by the decoder as applied to synthetic data generated by a generator of the GAN is used as part of feedback to the generator, thereby improving the performance of the generator over multiple training iterations. Further, the generator is trained for domain adaptation to generate synthetic data in a different domain than the original data used for an initial iteration of training of the GAN. In an embodiment, the GAN is trained in coordination with the decoder as described further below with respect to FIG. 3.

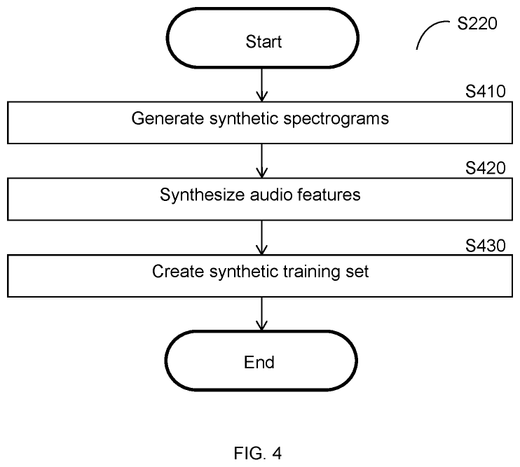

At S220, the trained GAN is applied in order to create a training set to be used for training an acoustic model. More specifically, the generator is utilized to generate synthetic spectrograms, and audio features are synthesized using the synthetic spectrograms. In an embodiment, the training set is created as described further below with respect to FIG. 4.

At S230, an acoustic model is trained using the synthesized audio. More specifically, the acoustic model is trained using at least the audio features of the synthesized audio. Because the synthesized audio is created based on spectrograms made using the GAN trained to produce authentic data as described above, the acoustic model can be trained using a sufficiently large amount of data to accurately predict acoustics. Moreover, in an embodiments where the synthetic audio is created using potential values in a domain of the acoustic model, the training of the acoustic model is further optimized for processing audio content in that domain.

At S240, audio content to be processed is received. The received audio content at least includes speech content containing acoustics. In an example implementation, the audio content may be captured by one or more microphones (e.g., the microphone 125, FIG. 1).

At S250, the acoustic model is applied to the audio content received at S240 in order to make predictions of acoustics. The predictions may be, for example, predictions of phonemes in different portions of the audio content.

At S260, a speech recognition model is applied based on the outputs of the acoustic model. The speech recognition model is designed to identify spoken words based on acoustics identified within the audio content. In an embodiment, S260 may include applying one or more automated speech recognition (ASR) techniques such as, but not limited to, Hidden Markov models (HMMs), deep learning ASR algorithms, combinations thereof, and the like.

At S270, the results of applying the speech recognition model are output as recognized speech and sent for subsequent processing. The subsequent processing may include, but is not limited to, modifying the speech recognition outputs (e.g., reformatting, cleaning, or otherwise adjusting the outputs for later use), providing the speech recognition outputs to a model or program which utilizes speech outputs (e.g., for speech-to-text processing or other uses), both, and the like. To this end, the outputs of the speech recognition process are provided as inputs to one or more processes for subsequent processing. In some implementations, the outputs of the speech recognition may be sent to one or more systems (e.g., the user device 120, FIG. 1) configured for such subsequent processing.

In some embodiments, S270 further includes utilizing the outputs for one or more subsequent processing steps such as, but not limited to, creating text (e.g., for a speech-to-text program), providing words identified among the recognized speech as inputs to a decision model (e.g., a model for determining which actions to take based on user inputs in the form of spoken words), and the like. To this end, in such embodiments, S270 may include applying models or programs configured to perform such subsequent processing to the outputs of the speech recognition or to features extracted from those outputs in order to perform the subsequent processing.

FIG. 3 is a flowchart S210 illustrating a method for training models of a generative adversarial network in coordination with a decoder according to an embodiment.

At S310, a generator is configured using a set of original data in a first domain. The generator is configured to generator synthetic data in a second domain. As noted above, the original data may be unknown. In particular, the domain of the original data may be unknown. The generator is trained during subsequent steps to generate synthetic data in the second domain regardless of the domain of the original data. The generator may have weights that are initialized as random values or preset values, and the weights may be initially altered based on the original data.

The set of original data represents characteristics of original audio content and may be, but is not limited to, a spectrogram. Likewise, the generator may be configured to generate synthetic data in the form of spectrograms. To obtain the original spectrograms, original audio-related data is obtained and may be processed in order to extract the features of the original spectrograms. Accordingly, in some embodiments, S310 further includes performing such extraction and generating the original spectrograms based, for example, on original audio content. To this end, in such an embodiment, S310 may further include performing signal processing in order to transform raw audio waveforms of the original audio content into vectors which can be utilized to extract features for the original spectrograms. Extracting the features may further include removing ambient noise or otherwise normalizing the waveforms. Non-limiting example featurization methods for extracting the features may be or may include calculating mel-frequency cepstral coefficients (MFCCs), performing perceptual linear prediction, or both.

At S320, the generator is applied in order to generate synthetic data in the second domain. In an embodiment, the synthetic data generated at S320 is synthetic spectrograms.

At S330, a decoder is applied to the synthetic data in the second domain generated at S320 in order to generate synthetic data in the first domain. This synthetic data in the first domain may be compared to original data in the first domain in order to determine losses caused by errors during generation of the synthetic data through the decoding.

At S340, a discriminator is applied to the synthetic data generated at S320 in order to determine whether portions of the synthetic data are real or fake. As noted above, the discriminator is configured to make predictions about whether data is real or authentic.

At S350, synthetic data that is determined to be fake is filtered out from the synthetic data and excluded from subsequent processing (i.e., during subsequent iterations of training). Filtering out fake data as determined by the discriminator allows for both reducing the amount of data to be processed during subsequent iterations as well as for improving the training by ignoring likely inauthentic data.

It should be noted that the application of the decoder as described with respect to S330 and the application of the discriminator as described with respect to S340 and S350 are discussed in a particular order for simplicity, but that these parts of the process are not limited to the particular order described. The decoder and the discriminator may be applied in parallel or in series, and may be applied in any order when applied in series.

At S360, losses accumulated during the application of the generator, the discriminator, and the decoder are determined. As noted above, the generator and the discriminator may each have a respective loss function which is used to calculate their respective losses when each model is applied. The sum of the losses calculated using the loss functions of the generator and the discriminator is therefore a loss for the GAN, or a GAN loss. The GAN loss is added to a decoder loss in order to determine a total accumulated loss for the system at the current iteration.

In an embodiment, S360 further includes determining the decoder loss. In a further embodiment, the decoder loss is determined based on the synthetic data in the first domain created using the decoder and the original data. More specifically, the synthetic data in the first domain created using the decoder may be compared to the original data, and the comparison may yield a difference. The decoder loss is or is determined based on this difference.

In an embodiment, the accumulated loss is calculated in accordance with Equation 1:

L=L_{GAN}+λ*L_{DEC} Equation 1

In Equation 1, L is the accumulated loss, L_{GAN} is the GAN loss, L_{DEC} is the decoder loss, and λ is a loss multiplier which may be, but is not limited to, a predetermined constant value.

At S370, the accumulated losses determined for this iteration at S360 are provided as feedback to the generator and execution returns to S320, where a new iteration of generating and analyzing synthetic data is performed. Providing such loss information as feedback to the generator allows for improving the ability of the generator to generate authentic synthetic data.

Moreover, because the loss data includes data from a model outside of the GAN, the training of the generator is further improved as compared to solutions which only train using feedback from the GAN itself. In this regard, it has been identified that using a decoder on the synthetic data generated by the generator to create synthetic data in the same domain as the original data allows for effectively comparing the synthetic data directly to the original data. Thus, it has been identified that a decoder can be specifically utilized to improve the training of the GAN in a manner unique to audio implementations.

FIG. 4 is a flowchart S220 illustrating a method for creating a synthetic training set for an acoustic model according to an embodiment.

At S410, synthetic spectrograms are generated. In an embodiment, the synthetic spectrograms are generated using a generator trained in coordination with a decoder, for example as described above with respect to FIG. 3.

In an embodiment, the synthetic spectrograms are generated in a domain used by the acoustic model for which a synthetic training set is to be generated. A domain is the set of potential values used for sets of data, and the domain used by the acoustic model is the domain only including potential values recognized by the acoustic model.

At S420, audio features are synthesized based on the synthetic spectrograms generated at S410. In an embodiment, S420 includes applying a voice encoder (vocoder) to the synthetic spectrograms in order to produce the audio features. The synthesized audio features simulate audio features of speech content which can be input to an acoustic model in order to make predictions such that these features can also be utilized to train the acoustic model.

At S430, a synthetic training set is created for the acoustic model using the synthesized audio features. The synthetic training set is utilized for training the acoustic model.

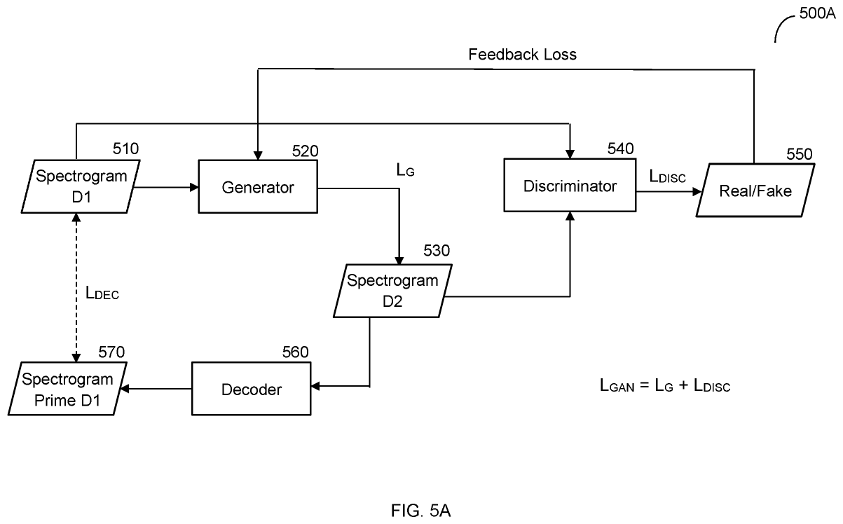

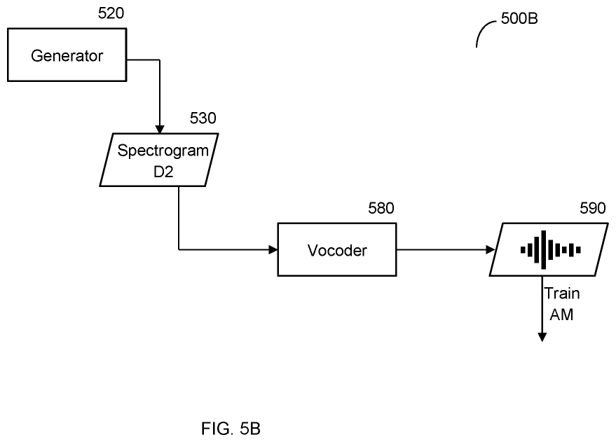

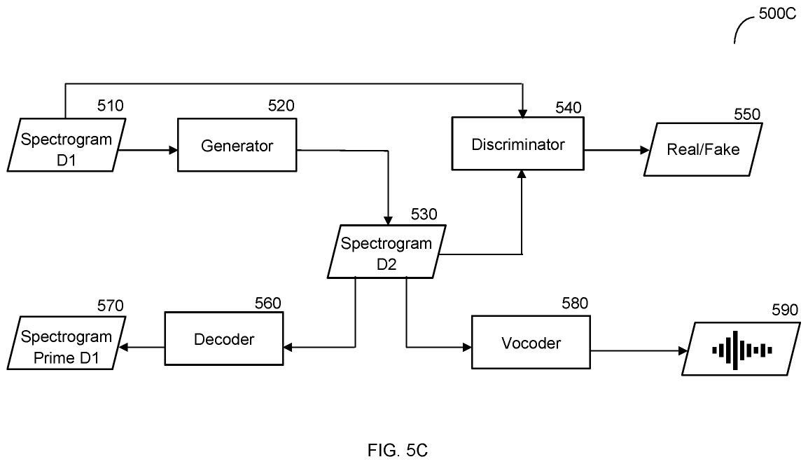

FIGS. 5A-C are flow diagrams utilized to illustrate various disclosed embodiments. FIG. 5A illustrates parts of a GAN training system used during training of a generator to generate synthetic data. A set of first spectrograms 510 in a first domain D1 is input to a generator 520 and used for initial configuration of the generator 520. The generator 520 is utilized to generate synthetic spectrograms 530 in a second domain D2 as well as to calculate a loss of the generator LG using a respective loss function (not shown).

The original spectrograms 510 as well as the synthetic spectrograms 530 are input to a discriminator 540 in order to train the discriminator 540 to determine whether each input spectrogram is real or fake. The discriminator 540 is further configured to determine whether each of the spectrograms 530 are real or fake as well as to calculate a loss of the discriminator L_{DISC} using a respective loss function (not shown). Spectrograms among the spectrograms 530 determined as fake may be excluded form use by the generator 520 and/or the discriminator 540 during subsequent training iterations.

A decoder 560 is also applied to the synthetic spectrograms 530 in the second domain in order to create synthetic spectrograms prime 570 in the first domain. The difference between the original spectrograms 510 and the synthetic spectrograms prime 570 may be used to determine a loss of the decoder L_{DEC}.

The combined losses of the of the generator LG and of the discriminator L_{DISC} form the loss of the GAN L_{GAN}, and the accumulated losses of both the GAN L_{GAN} and of the decoder L_{DEC} are used as feedback to the generator 520.

FIG. 5B illustrates a process for applying the generator 520 in order to synthesize audio data for use in training an acoustic model. The generator 520 is utilized to create synthetic spectrograms 530. The synthetic spectrograms 530 are input to a voice encoder (vocoder) 580 in order to synthesize audio features 590. The synthesized audio features 590 are collected into a training set for use in training an acoustic model (AM, not shown).

FIG. 5C illustrates the various components used during training and application of the generator 520 which make up a synthetic audio composer such as the synthetic audio composer 130, FIG. 1, as well as the flows of data between these components with.

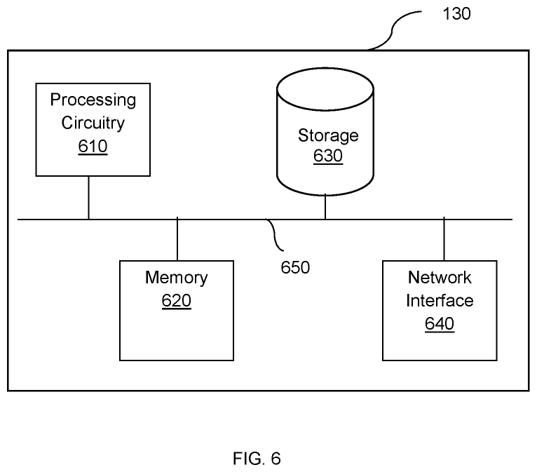

FIG. 6 is an example schematic diagram of a synthetic audio composer 130 according to an embodiment. The synthetic audio composer 130 includes a processing circuitry 610 coupled to a memory 620, a storage 630, and a network interface 640. In an embodiment, the components of the synthetic audio composer 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the synthetic audio composer 130 to communicate with, for example, the user device 120, the databases 140, both, and the like.

It should be understood that the embodiments described herein are not limited to the specific architecture illustrated in FIG. 6, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for training machine learning models, comprising:
synthesizing an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and
training an acoustic model using the synthesized audio data set.

2. The method of claim 1, wherein the synthesized audio data set is a first audio data set, further comprising:
applying the trained acoustic model to features from a second audio data set in order to generate a plurality of acoustic predictions for the second audio data set.

3. The method of claim 2, further comprising:
applying at least one speech recognition model to the plurality of acoustic predictions for the audio data set.

4. The method of claim 1, wherein synthesizing the audio set further comprises:
generating, using the generator, the plurality of synthetic audio features; and
inputting the plurality of synthetic audio features to a voice encoder, wherein the audio data set is created based on an output of the voice encoder.

5. The method 1, wherein the generator is included in a generative adversarial network (GAN), the GAN further including a discriminator configured to predict whether outputs of the generator are authentic, wherein the generator is trained further in coordination with the discriminator.

6. The method of claim 5, wherein the discriminator is initially trained based on the original audio data and a plurality of training synthetic audio features generated by the generator.

7. The method 5, further comprising:
training the GAN in a plurality of each iterations, wherein training the GAN at each iteration further comprises:
generating, via the generator, a plurality of training synthetic audio features in the second domain;
determining, via the discriminator, whether each the training synthetic audio features is authentic.

8. The method 7, wherein training the GAN at each iteration further comprises:
discarding each training synthetic audio feature that is not determined to be authentic, wherein the discarded features are not utilized during subsequent iterations; and
keeping each training synthetic audio feature that is determined to be authentic, wherein the kept features are utilized during subsequent iterations.

9. The method 7, wherein training the GAN at each iteration further comprises:
determining a total loss based on a loss of the GAN and a loss of the decoder; and
providing the determined loss as feedback to the GAN.

10. The method of claim 9, wherein determining the loss at each iteration further comprises:
creating, via the decoder, a plurality of training synthetic audio features in the first domain; and
comparing the plurality of training synthetic audio features in the first domain to the original audio data, wherein the loss of the decoder is determined based on the comparison.

11. The method of claim 9, wherein each of the generator and the discriminator has a respective loss function, wherein the loss provided to the generator as feedback at each iteration is determined based further on an output of the loss function of each of the generator and the discriminator at the iteration.

12. The method of claim 1, wherein the generator is configured to output synthetic audio features as spectrograms in the second domain, wherein the decoder is configured to transform the spectrograms in the second domain into spectrograms in the first domain.

13. A non-transitory computer readable medium having stored thereon instructions for causing a processing circuitry to execute a process, the process comprising:
synthesizing an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and
training an acoustic model using the synthesized audio data set.

14. A system for audio processing, comprising:
a processing circuitry; and
a memory, the memory containing instructions that, when executed by the processing circuitry, configure the system to:
synthesize an audio data set in a second domain using a generator, wherein the generator is a machine learning model trained in coordination with a decoder, wherein the generator is trained based on original audio data in a first domain to output synthetic audio features in the second domain, wherein the decoder is configured to transform audio features in the second domain into audio features in the first domain; and
train an acoustic model using the synthesized audio data set.

15. The system of claim 14, wherein the synthesized audio data set is a first audio data set, wherein the system is further configured to:
apply the trained acoustic model to features from a second audio data set in order to generate a plurality of acoustic predictions for the second audio data set.

16. The system of claim 15, wherein the system is further configured to:
apply at least one speech recognition model to the plurality of acoustic predictions for the audio data set.

17. The system of claim 14, wherein the system is further configured to:
generate, using the generator, the plurality of synthetic audio features; and
input the plurality of synthetic audio features to a voice encoder, wherein the audio data set is created based on an output of the voice encoder.

18. The system 14, wherein the generator is included in a generative adversarial network (GAN), the GAN further including a discriminator configured to predict whether outputs of the generator are authentic, wherein the generator is trained further in coordination with the discriminator.

19. The system of claim 18, wherein the discriminator is initially trained based on the original audio data and a plurality of training synthetic audio features generated by the generator.

20. The system 18, wherein the system is further configured to:
train the GAN in a plurality of each iterations, wherein the system is further configured to, at each iteration:
generate, via the generator, a plurality of training synthetic audio features in the second domain;
determine, via the discriminator, whether each the training synthetic audio features is authentic.

21. The system 20, wherein the system is further configured to, at each iteration:
discard each training synthetic audio feature that is not determined to be authentic, wherein the discarded features are not utilized during subsequent iterations; and
keep each training synthetic audio feature that is determined to be authentic, wherein the kept features are utilized during subsequent iterations.

22. The system 20, wherein the system is further configured to, at each iteration:
determine a total loss based on a loss of the GAN and a loss of the decoder; and
provide the determined loss as feedback to the GAN.

23. The system of claim 22, wherein the system is further configured to, at each iteration:
create, via the decoder, a plurality of training synthetic audio features in the first domain; and
compare the plurality of training synthetic audio features in the first domain to the original audio data, wherein the loss of the decoder is determined based on the comparison.

24. The system of claim 22, wherein each of the generator and the discriminator has a respective loss function, wherein the loss provided to the generator as feedback at each iteration is determined based further on an output of the loss function of each of the generator and the discriminator at the iteration.

25. The system of claim 14, wherein the generator is configured to output synthetic audio features as spectrograms in the second domain, wherein the decoder is configured to transform the spectrograms in the second domain into spectrograms in the first domain.
